(19) United States
(12) Patent Application Publication
(10) Pub. No.: US 2004/0143937 A1
(43) Pub. Date: Jul. 29, 2004

(54) Clipper seams

(76) Inventor: Richard F. Allen, Ilkley (GB)

Correspondence Address: BARLOW, JOSEPHS & HOLMES, LTD., 101 DYER STREET, 5TH FLOOR, PROVIDENCE, RI, 02903, US

(21) Appl. No.: 10/389,639

(22) Filed: Mar. 14, 2003

(30) Foreign Application Priority Data
Jan. 25, 2003 (GB) 0301782.9

(51) Int. Cl. E05D 7/00

(52) U.S. Cl. 16/373

(57) ABSTRACT

The present invention provides an improvement in a clipper seam used to join the ends of a fabric belt to form a continuous conveying member. The seam is formed using an array of P-shaped loop members having a barb on the shank ends thereof. The loop members have two different lengths and are placed along the terminal end of the fabric in an alternating array to distribute the transferred load over a greater surface of the fabric. The barbs engage the fabric and an adhesive is applied to the fabric over the shanks of the installed loop members. The ends of the fabric are brought together to form a continuous belt and a pintel is installed into the P-shaped members to join the two ends.

This invention relates to improvements in clipper seams.

Clipper seams are used to join the ends of belts or other industrial fabrics such as papermachine clothing and filtration media to form endless structures for passing continuously about drums and rollers in related machinery. Fabrics of woven material may be seamed by extending machine direction yarns beyond the last cross-direction yarns and weaving the ends back into the fabric to produce a series of loops on each fabric end which are interdigitable to form a tunnel through which a pintle wire can be passed to join the ends of the fabric. In the case of nonwoven or heavily coated or impregnated fabrics however, for example as often used in dryer fabrics and filter fabrics, extendable yarns are either absent or unusable due to the impregnation of the fabric. In these cases, a seaming tunnel is formed by an array of metal clips in the form of U-shaped wire loops one or both ends of which are embedded in the material of the end region of the fabric, and the loops are interdigitatable with those on the other end of the fabric to form a seaming tunnel for passage of a pintle wire. An embodiment of such a clipper seam is shown in U.S. Pat. No. 3,576,055 (GISBOURNE).

When such an arrangement is used in a papermachine fabric, such as a dryer belt, the seam is often protected by a flap of the fabric, or buried in a multilayer structure of the fabric, or the belt is thicker than the depth of the wire loops. However, filter belts or pulp dewatering belts are much less bulky than papermachine belts, and the metal loops stand proud of the belt in almost all filtering operations it is necessary to remove the solid cake from the belt surface by using a scraper blade set just above the belt surface. The scraper blade as a result has a tendency to catch the metal hooks every time the seam passes below the scraper leading to wear of the metal hooks, which causes the latter to weaken and fail unfastening the belt and also the constant snagging of the metal hooks on the blade pulls at the point where the hooks puncture the belt. Failure in the latter case is due to formation of a tear or hole in the belt.

A recent modification of this design is to apply a thickness of an adhesive material to the fabric edge regions on the side or sides from which the hooks engage into the fabric of the belt. The adhesive sits proud of the surface and wears sacrificially instead of the metal hooks, and tears and holes caused by the metal hooks pulling at the belt are reduced because the adhesive immobilises the hooks with the belt so that tension forces are distributed over as great an area as possible.

It has been found however that despite the improvements which are offered by the use of adhesive in this way the adhesive layer or body does not have permanent resistance to abrasion caused by the scraper blade. In consequence the adhesive eventually wears down exposing the hooks, or delaminates from the belt in response to repeated scraping. The use of harder more resistant adhesives is desirable but not possible as these are increasingly brittle with increasing hardness and will fracture very easily during use under flexure stress, as when passing around guide and drive rollers. Such fractured adhesive will wear or fall off from the belt very quickly, possibly contaminating the product.

Accordingly, an object of the invention is to provide a clipper seam construction which will achieve extended belt life and substantially reduce or overcome the problems noted above.

The present invention provides a clipper seam construction comprising a row of loop defining members provided on each end of a fabric which can be interdigitated to form a tunnel for a pintle joining member, each of the loop defining members having at least one hook for engaging in the respective end of the fabric, and each end of the fabric having an adhesive layer covering the hooks of the loop defining members, characterised in that the adhesive layer comprises an adhesive material which incorporates a hard material in the adhesive material.

The term “hard” in the context of this description means a material which is at least harder than the matrix in which it is' embedded. The hard material way comprise particles which are preferably of stainless steel, but can be any of HASTELLOY (Trade Mark) metal, or alumina, zircon, silica (e.g. as sand) or glass balatini or microspheres.

The mean particle size may be about 100 μm, and all the particles preferably pass through a 300 μm mesh, the particles being sieved to remove coarse material.

The hard particulate material may comprise up to 50% by weight of the total adhesive layer. A more typical proportion of the hard particulate material may be in the order of 20% by weight of the adhesive material.

The hard material may comprise a fibrous material such as metal fibres, e.g. steel or HASTELLOY (Trade Mark), ceramic fibres crystalline or amorphous mineral fibres, mineral wool, or glass fibres. Ceramic fibres can be alumina, alumino-silicate, calcium silicates, or other silicate materials. A mix of fibres and particulate material maybe used as the hard material.

The loop defining members maybe in the form of a generally U-shaped wire or rod members, the ends of the limbs of the U-shape being turned inwardly to form barbs which engage in the fabric, as shown in U.S. Pat. No. 3,576,055 noted above, or may have a generally P-shaped form, with one limb of the member turned in to form a loop, and the other provided with an inturned barbed end to engage in the fabric. In the former case, both sides of the fabric may be provided with an adhesive layer to cover the limbs of the loop defining members, at least the adhesive layer on the upstream (filter cake accumulating) side of the fabric having a hard particulate material therein, preferably both. In the second case, the adhesive layer with hard particulate material therein is provided on the side of the fabric overlain by the longer barbed limb of the P-shaped loop defining member.

The loop defining members may be arranged with alternating longer and shorter limbed forms, to reduce stress acting on a single zone of the fabric and thus reduce the risk of tearing.

An embodiment of the invention will now be described by way of example, with reference to the accompanying drawings wherein:

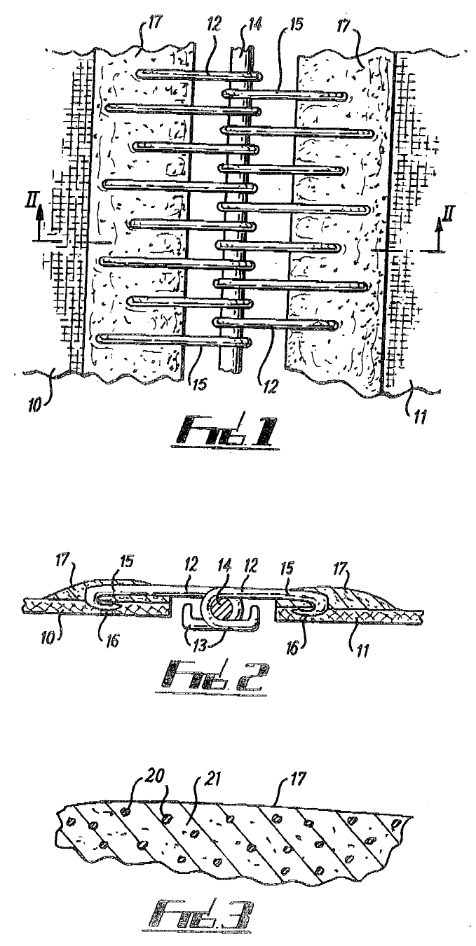

FIG. 1 is a plan view of a short length of a clipper seam in accordance with the invention;

FIG. 2 is a sectional view on line II-II of FIG. 1; and

FIG. 3 is a much enlarged diagrammatic cross-section of an adhesive matrix forming part of the clipper seam.

As shown in the drawings, a clipper seam is used to join the ends of a belt or filter fabric 10,11 to form an endless member for use for example in filtration. The scam is formed by an array of P-shaped loop defining members 12 on each fabric end. The members 12 of the arrays are interdigitatable with those of the opposed array as shown in FIG. 1, and have outer ends 13 which are turned back to form an almost complete loop. These loops are interdigitated to form a tunnel through which a pintle 14 comprising a robust monofilament or multifilament yarn of e.g. nylon is passed the members 12 also each comprise a shank 15 which terminates on a barbed end 16 which engages on the fabric 10,11. The members 12 are provided with shanks 15 of two differing lengths, and members with longer and shorter shanks 15 are alternated in each array, as shown in FIG. 1 so that the barbed ends 16 engage in the fabric in two different zones, spreading the load acting on the fabric and reducing the risk of tearing of the fabric.

As shown in FIG. 2, the ends of the belt 10,11 are each covered on the face of the fabric overlain by the shanks 15 of the members 12, by an adhesive layer 17, which covers and encapsulates the shanks 15 of the member 12. This adhesive layer 11 protects the shanks 15 against wear and pulling out from the fabric by a scraper blade acting on the fabric at intervals to remove accumulated filter cake during operation of the filter. In accordance with the invention, this adhesive layer 17 includes particles 20 of a harder material included in the mean matrix 21 of the adhesive material. The matrix 21 is in the preferred embodiment polyurethane based, and the harder particles are of steel. The inclusion of harder particles in the adhesive markedly reduces wear of the adhesive and thus helps to prevent premature failure of the belt.

### EXAMPLE OF ADHESIVE COWOSITION

The adhesive matrix is formed by mixing four components

| | |
|---|---|
| first polyurethane | ) chosen to give optimum flexibility |
| second polyurethane | ) or other properties |
| isocyanate hardener | |
| pigment | according to colour required |

A typical laboratory trial batch mix comprises the following quantities and stages:

1. Mix 5 kg first polyurethane with 4.5 kg second polyurethane

2. Separately mix 5 kg hardener with pigment

3. Mix the two products in proportions of 25.3 g of the second mix, per 100 g of the first (polyurethane) mix.

Once the basic adhesive mixture has been prepared, stainless steel powder is added thereto. The stainless steel is 316L grade, with a mean particle size of 100 μm. The particles are sieved through a 300 μm mesh to remove coarse material before being added. All mixing was carried out in a laboratory turbine mixer.

To test the effects of adding stainless steel particles to the mixture a plurality of batches were made up with different proportions of stainless steel particles, as set out below in Table 1.

TABLE 1

| | | | Stainless | % steel by |
|---|---|---|---|---|
| Batch | Polyurethane/g | Hardener/g | steel/g | weight |
| A | 100 | 25.3 | 0 | 0 |
| B | 100 | 25.3 | 10 | 7.3 |
| C | 100 | 25.3 | 20 | 13.7 |
| D | 100 | 25.3 | 120 | 48.9 |

To study the effect of the addition of stainless steel on the abrasion resistance and mechanical properties, films of each formulation were cast onto MELINEX film, using the laboratory K-bar 500 to give a nominal wet film thickness of 0.5 mm. This resulted in cured polymer films of between 0.4 and 0.5 mm thickness.

After curing the samples were peeled from the MELINEX film and employed for abrasion testing. The results of the abrasion tests are shown in Table 2 below. This compares the wear (as decrease in thickness) of a 0.5 mm film when cycling against 240 grit silicon carbide paper. The results have been normalized against a particle free film in the last column.

TABLE 2

| | | | Normalised |
|---|---|---|---|
| | Stainless steel % | Mean wear after 800 | mean wear life |
| Batch | wt | abrasion cycles (mm) | compared to 0% steel |
| A | 0 | 0.112 | 1 |
| B | 7.3 | 0.052 | 2.16 |
| C | 13.7 | 0.054 | 2.08 |
| D | 48.9 | 0.027 | 4.11 |

It is thus demonstrated that a 7.3 or 13.7% by weight addition of stainless steel powder doubles the life of the adhesive film and a 48.9% addition of steel particles extends life by at least four times.

It is thus expected that useful results will be obtained with additions of steel particles from less than 10% by weight to in excess of 50% by weight.

It is also expected the relatively hard particles other than steel will give useful results, including zircon, alumina, sand (silica or silicate powder), glass, microbeads or balatini, and HASTELLOY metal. The choice of hard particles is determined by the conditions which the belt is likely to encounter. The normal choice will be stainless steel particles. However if oxidising conditions are expected the mole inert HASTELLOY metal may be used. If a metal is not suitable then one of the inorganic minerals or materials may be used.

Polyurethane or other adhesive formulations other than as set out in the examples may be used to form the matrix of the adhesive which contains the relatively hard particles.

Where hooks engage into the belt from both sides, both sides of the ends of the belt may be provided with an adhesive strip, or only the side of the belt engaged by the scraper blade may be so provided.

The properties of the adhesive matrix can be optionally altered using viscosity modifiers or wetting agents to improve the properties. Viscosity modifiers may be used to thicken the adhesive before adding the hard particles to prevent the particles from sinking through the uncured matrix and to ensure an even distribution of particles. Where viscosity is so increased, wetting agents may be needed to help the thickened matrix penetrate the filter cloth to obtain a satisfactory bond.

Instead of hard particulate material, hard fibrous material may be used, or a blend of particulate and fibrous materials. The fibres may be selected from metal fibres such as steel or HASTELLOY, inorganic fibres such as ceramic fibres, crystalline or amorphous mineral fibres or wools, and glass fibres. The ceramic fibres may comprise alumina, alumino-silicate, calcium silicates or other silicate materials.

1. A clipper seam construction comprising:—
a row of loop defining members provided on each end of a fabric;
said loop defining members on one end of said fabric being capable of being interdigitated with said loop defining members on said other end of said fabric to form a tunnel for a pintle joining member;
each said loop defining member having at least one hook for engaging in the respective end of the fabric;
each end of said fabric having an adhesive layer covering the hooks of said loop defining members, and
said adhesive layer comprising an adhesive material which incorporates hard material in the adhesive material.

2. A clipper seam construction as claimed in claim 1, wherein said hard material is a particulate material selected from the group comprising stainless steel, HASTELLOY (Trade Mark), metal, alumina, zircon, silica, glass balatini or glass microspheres.

3. A clipper seam construction as claimed in claim 1 when said hard material is a fibrous material selected from the group comprising metal fibres, ceramic fibres, mineral fibres, mineral wool and glass fibres.

4. A clipper seam construction as claimed in claim 2, wherein said hard particulate material has a mean particle size of about 100 mm, and all the particles pass through a 300 mm mesh.

5. A clipper seam as claimed in claim 1, wherein the hard material comprises up to 50% by weight of the total adhesive material.

6. A clipper seam as claimed in claim 4 wherein the bard material comprises in the order of 20% by weight of the adhesive material.

7. A clipper seam as claimed in claim 1, wherein said loop defining members are each in the form of generally U-shaped wire or rod members, the ends of the limbs of the U-shape being inwardly turned and forming barbs which engage in the fabric.

8. A clipper seam as claimed in claim 1, wherein said loop defining members are each in the form of generally P-shaped wire or rod members, the end of the limb of the P-shape being inwardly turned and forming a barb which engages in the fabric.

9. A clipper seam as claimed in claim 6, wherein both sides of the fabric are provided with an adhesive layer to cover the limbs of the loop defining members, and at least the adhesive layer on an upstream side of the fabric having said hard material therein.

10. A clipper seam as claimed in claim 1, wherein each said loop defining member has a limb connecting a loop end part thereof to said hook, the loop defining members on each end of the fabric being arranged so that respective loop defining members having longer and shorter limbs are alternated so that said hooks engage the fabric at different distances from the edge.
